(19) United States
(12) Patent Application Publication
(10) Pub. No.: US 2025/0230663 A1
(43) Pub. Date: Jul. 17, 2025

(54) Weather Head Top Cap Device

(71) Applicant: Conor McClure, Seeley Lake, MT (US)

(72) Inventor: Conor McClure, Seeley Lake, MT (US)

(21) Appl. No.: 18/904,210

(22) Filed: Oct. 2, 2024

Related U.S. Application Data
(60) Provisional application No. 63/621,005, filed on Jan. 15, 2024.

(51) Int. Cl. E04D 13/147; F16L 55/115; H02G 3/04

(52) U.S. Cl. CPC E04D 13/1476; F16L 55/115; H02G 3/0418

(57) ABSTRACT

A weather head top cap device is provided. The device is comprised of a first half, a second half, and a cap. The three pieces of the device can be attached together via integrated fasteners to form a weather head top cap. One of the halves is further comprised of a member that extends outwards from the half, wherein the member is comprised of at least one channel that supports and routes wiring exiting the cap. As a result, a user can easily assemble the device to replace a broken weather head.

### CROSS-REFERENCE TO RELATED APPLICATION

The present application claims priority to, and the benefit of, U.S. Provisional Application No. 63/621,005, which was filed on Jan. 15, 2024, and is incorporated herein by reference in its entirety.

### FIELD OF THE INVENTION

The present invention relates generally to the field of weather heads. More specifically, the present invention relates to a weather head top cap device comprised of a three-piece assembly with an integrated member that supports and routes wiring exiting the device. Accordingly, the present disclosure makes specific reference thereto. Nonetheless, it is to be appreciated that aspects of the present invention are also equally applicable to other like applications, devices, and methods of manufacture.

### BACKGROUND

Weather heads, the external fittings where overhead power lines connect to a building, are crucial for electrical safety and functionality. When weather heads fail, they can lead to code violations, necessitating immediate attention either from certified electricians or power company technicians. The repair process for a damaged weather head can be both time-consuming and expensive, and there is always the risk of future failures even after repair. This repetitive cycle of replacing and fixing broken weather heads not only incurs significant costs over time but also introduces a layer of frustration for property owners. Continual maintenance issues with weather heads can impact the overall reliability of a building's electrical supply, emphasizing the importance of durable solutions and proactive maintenance strategies. In addition, wiring exiting a weather head may not always be properly supported and routed.

Therefore, there exists a long-felt need in the art for an improved weather head. There also exists a long-felt need in the art for a weather head top cap device. More specifically, there exists a long-felt need in the art for a weather head top cap device that provides a top cap for a weather head that can be easily assembled by a property owner. Further, there exists a long-felt need in the art for a weather head top cap device that provides a top cap for a weather head that can be easily assembled by a property owner and wherein the device supports and routes wiring in an organized manner.

The subject matter disclosed and claimed herein, in one embodiment thereof, comprises a weather head top cap device. The device is comprised of a first half, a second half, and a cap. The three pieces of the device can be attached together via integrated fasteners to form a weather head top cap. One of the halves is further comprised of a member that extends outwards from the half, wherein the member is comprised of at least one channel that supports and routes wiring exiting the cap. As a result, a user can easily assemble the device to replace a broken weather head.

In this manner, the weather head top cap device of the present invention accomplishes all the foregoing objectives and provides an improved weather head that provides a top cap for a weather head that can be easily assembled by a property owner. Further, the device supports and routes wiring in an organized manner.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a weather head top cap device comprised of a weather head cap comprised of a first half, a second half, and a cap that can be easily attached to one another to form a weather head top cap. The first half and the second half are preferably semi-cylindrical and are each comprised of an opening. The first half is comprised of at least one fastener that attaches to at least one fastener of the second half to allow the halves to removably attach to form a generally tubular and cylindrical structure.

The second end of each half is further comprised of at least one fastener that allows at least one fastener of a cap to attach to both halves. The cap is hollow and is further comprised of at least one opening that allows wiring to exit the device once the halves and cap have been attached to one another. More specifically, wiring can be fed through the openings such that the wiring extends out from the second end of each half into and through the cap, and out of the cap via the opening of the cap. More specifically, the second end of the first half is comprised of at least one member that extends outwards from the half, wherein the member is comprised of at least one wire receiving structure, which may be in the form of a groove, an opening, a channel, etc., in different embodiments. The channel receives the wiring and ensures the wiring is organized and supported.

The present invention is also comprised of a method of using the device. First, a device is provided comprised of a first half comprised of a wire-receiving member comprised of at least one wire-receiving structure, a second half, and a cap. Then, the first half can be attached to the second half via fasteners around the exterior of a piece of conduit on a residential roof or other area. Next, wiring can be routed from the conduit, through the halves, and through at least one wire-receiving member of the member. Finally, the cap can be secured to both halves to protect the wiring.

Accordingly, the weather head top cap device of the present invention is particularly advantageous as it provides an improved weather head that provides a top cap for a weather head that can be easily assembled by a property owner. Further, the device supports and routes wiring in an organized manner. In this manner, the weather head top cap device overcomes the limitations of existing weather heads known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded perspective view of a first half and a second half of one potential embodiment of a weather head top cap device of the present invention in accordance with the disclosed architecture;

FIG. 2 illustrates a partially exploded perspective view of a cap, a first half and a second half of one potential embodiment of a weather head top cap device of the present invention in accordance with the disclosed architecture;

FIG. 3 illustrates a perspective view of one potential embodiment of a weather head top cap device of the present invention in accordance with the disclosed architecture;

FIG. 4 illustrates a perspective view of one potential embodiment of a weather head top cap device of the present invention attached to a conduit and without a cap in accordance with the disclosed architecture;

FIG. 5 illustrates a perspective view of one potential embodiment of a weather head top cap device of the present invention attached to a conduit and with a cap in accordance with the disclosed architecture; and

FIG. 6 illustrates a flowchart of a method of using one potential embodiment of a weather head top cap device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved weather head. There also exists a long-felt need in the art for a weather head top cap device. More specifically, there exists a long-felt need in the art for a weather head top cap device that provides a top cap for a weather head that can be easily assembled by a property owner. Further, there exists a long-felt need in the art for a weather head top cap device that provides a top cap for a weather head that can be easily assembled by a property owner and wherein the device supports and routes wiring in an organized manner.

The present invention, in one exemplary embodiment, is comprised of a weather head top cap device. The device comprised of a weather head cap comprised of a first half, a second half, and a cap. All three pieces can be easily attached to one another to form a weather head top cap. The first half and the second half are preferably semi-cylindrical and are each comprised of an opening, wherein the first half is comprised of at least one fastener that attaches to at least one fastener of the second half to allow the halves to removably attach to form a generally tubular and cylindrical structure.

The second end of each half is further comprised of at least one fastener that allows at least one fastener of a cap to attach to both halves. The cap is hollow and is further comprised of at least one opening that allows wiring to exit the device once the halves and cap have been attached to one another. More specifically, wiring can be fed through the openings such that the wiring extends out from the second end of each half into and through the cap, and out of the cap via the opening of the cap. More specifically, the second end of the first half is comprised of at least one member that extends outwards from the half, wherein the member is comprised of at least one wire receiving structure, which may be in the form of a groove, an opening, a channel, etc., in different embodiments. The channel receives the wiring and ensures the wiring is organized and supported.

The present invention is also comprised of a method of using the device. First, a device is provided comprised of a first half comprised of a wire-receiving member comprised of at least one wire-receiving structure, a second half, and a cap. Then, the first half can be attached to the second half via fasteners around the exterior of a piece of conduit on a residential roof or other area. Next, wiring can be routed from the conduit, through the halves, and through at least one wire-receiving member of the member. Finally, the cap can be secured to both halves to protect the wiring.

Accordingly, the weather head top cap device of the present invention is particularly advantageous as it provides an improved weather head that provides a top cap for a weather head that can be easily assembled by a property owner. Further, the device supports and routes wiring in an organized manner. In this manner, the weather head top cap device overcomes the limitations of existing weather heads known in the art.

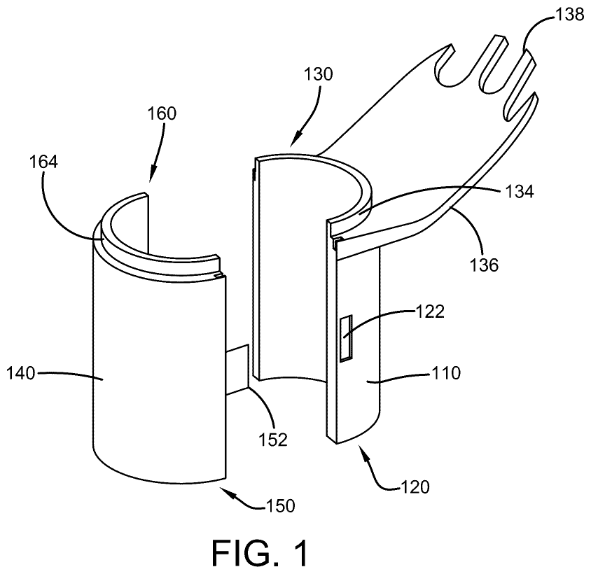

Referring initially to the drawings, FIG. 1 illustrates an exploded perspective view of a first half and a second half of one potential embodiment of a weather head top cap device 100 of the present invention in accordance with the disclosed architecture. The device 100 is comprised of a weather head cap comprised of a first half 110, a second half 140, and a cap 170 that can be easily attached to one another to form a weather head top cap. The device 100 is preferably made from a plastic or metal material.

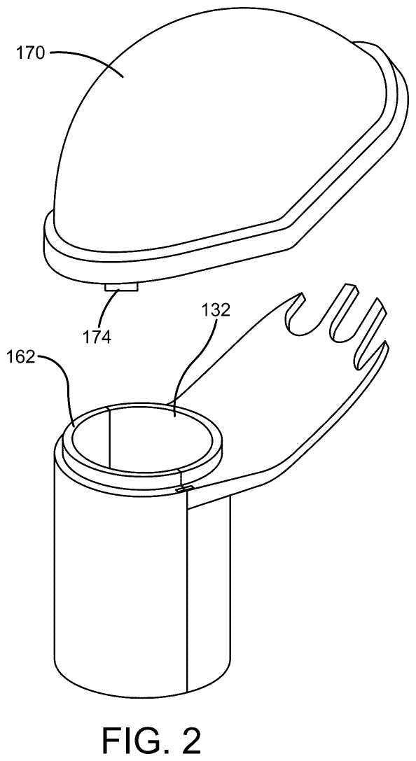

The first half 110 and the second half 140 are preferably semi-cylindrical and are each comprised of a first end 120, 150, and a second end 130, 160 with an opening 132, 162 that extends between the same of each half 110, 140. The first half 110 is comprised of at least one fastener 122 that attaches to at least one fastener 152 of the second half 140 to allow the halves 110, 140 to removably attach to form a generally tubular and cylindrical structure, as seen in FIG. 2. The fasteners 122, 152 may be any reciprocating fastener type such as, but not limited to, male and female, clip and opening, magnets, tongue and groove, etc.

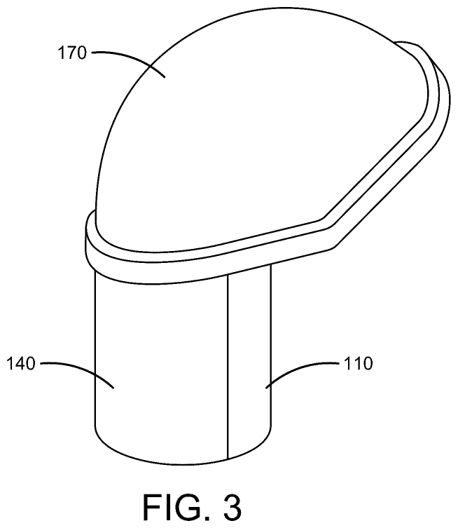

The second end 130, 160 of each half 110, 140 is further comprised of at least one fastener 134, 164. The fastener 134, 164 is preferably a lip. The fasteners 134, 164 allow at least one fastener 174 of a cap 170 to attach to both halves 110, 140, as seen in FIG. 3. The fastener 174 of the cap 170 is preferably a groove that receives the fasteners 134, 164. However, the fasteners 134, 164, 174 may be any reciprocating fastener type such as, but not limited to, male and female, tongue and groove, magnets, clip and opening, threads, etc.

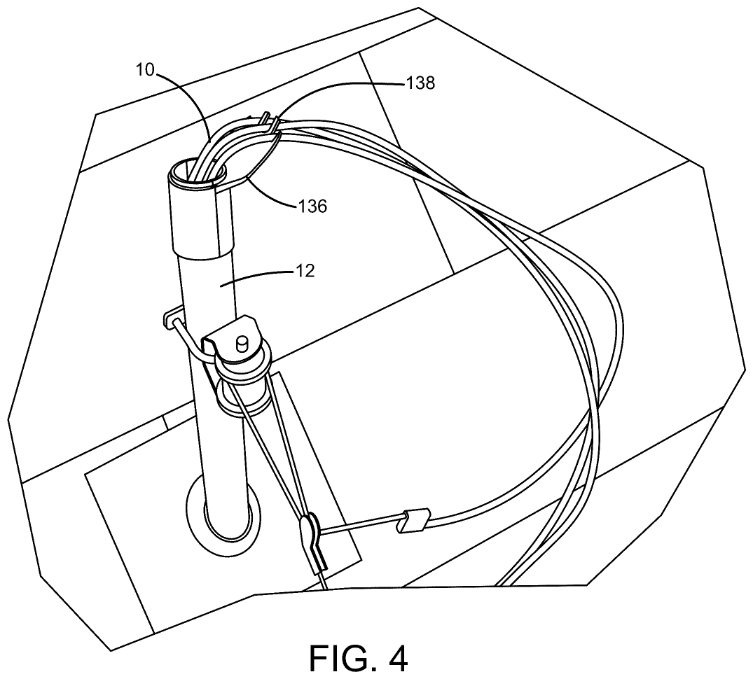

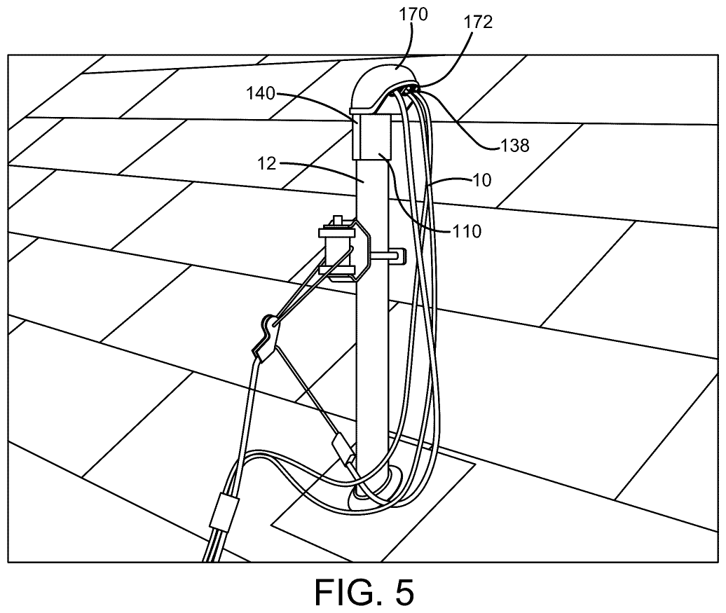

The cap 170 is hollow and is further comprised of at least one opening 172 that allows wiring 10 to exit the device 100 once the halves 110, 140, and cap 170 have been attached to one another. More specifically, wiring 10 can be fed through the openings 132, 162 such that the wiring 10 extends out from the second end 130, 160 of each half 110, 140, into and through the cap 170, and out of the cap 170 via the opening 172 of the cap 170. More specifically, the second end 130 of the first half 110 is comprised of at least one member 136 that extends outwards from the half 110, wherein the member 136 is comprised of at least one wire receiving structure 138, which may be in the form of a groove, an opening, a channel, etc., in different embodiments. The channel 138 receives the wiring 10 and ensures the wiring 10 is organized and supported, as seen in FIG. 4 and FIG. 5. The member 136 preferably forms an angle between 0 and 180 degrees relative to the vertical axis of one or both halves 110, 140.

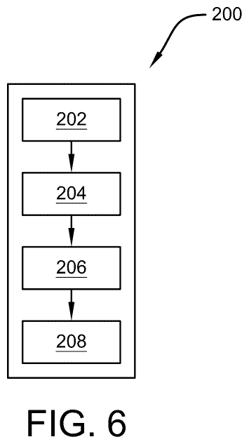

The present invention is also comprised of a method of using 200 the device 100, as seen in FIG. 6. First, a device 100 is provided comprised of a first half 110 comprised of a wire-receiving member 136 comprised of at least one wire-receiving structure 138, a second half 140, and a cap 170 [Step 202]. Then, the first half 110 can be attached to the second half 140 via fasteners 122, 152 around the exterior of a piece of conduit 12 on a residential roof or other areas [Step 204]. Next, wiring 10 can be routed from the conduit 12, through the halves 110, 120, and through at least one wire-receiving member 138 of the member 136 [Step 206]. Finally, the cap 170 can be secured to both halves 110, 140 to protect the wiring 10 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “weather head top cap device” and “device” are interchangeable and refer to the weather head top cap device 100 of the present invention.

Notwithstanding the foregoing, the weather head top cap device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the weather head top cap device 100 as shown in the FIGS. are for illustrative purposes only, and that many other sizes and shapes of the weather head top cap device 100 are well within the scope of the present disclosure. Although the dimensions of the weather head top cap device 100 are important design parameters for user convenience, the weather head top cap device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A weather head top cap device comprising:
a first half comprised of a first fastener and a member comprised of a wire-receiving structure;
a second half comprised of a second fastener; and
a cap comprised of an opening, and a third fastener.

2. The weather head top cap device of claim 1, wherein the first fastener and the second fastener are comprised of a pair of reciprocating fasteners.

3. The weather head top cap device of claim 1, wherein the first fastener and the second fastener are comprised of a male fastener and a female fastener, a clip fastener and an opening fastener, a tongue fastener and a groove fastener, or a magnet.

4. The weather head top cap device of claim 1, wherein the first half is comprised of a fourth fastener.

5. The weather head top cap device of claim 4, wherein the second half is comprised of a fifth fastener.

6. The weather head top cap device of claim 5, wherein the third fastener, the fourth fastener, and the fifth fastener are comprised of reciprocating fasteners.

7. The weather head top cap device of claim 6, wherein the fourth fastener and the fifth fastener are comprised of a male fastener and the third fastener is comprised of a female fastener.

8. The weather head top cap device of claim 1, wherein the member forms an angle between 0 and 180 degrees relative to a vertical axis of the first half.

9. The weather head top cap device of claim 1, wherein the wire-receiving member is comprised of a channel, an opening, or a groove.

10. A weather head top cap device comprising:
a first half comprised of a first fastener, a second fastener, and a member comprised of a wire-receiving structure and a second half comprised of a second fastener and a third fastener, wherein the first half attaches to the second half via the first fastener and the second fastener; and
a cap comprised of an opening, and a fourth fastener that attaches to the second fastener and the third fastener.

11. The weather head top cap device of claim 10, wherein the first half and the second half form a cylindrical shape.

12. The weather head top cap device of claim 10, wherein the member forms an angle between 0 and 180 degrees relative to a vertical axis of the first half.

13. The weather head top cap device of claim 10, wherein the wire-receiving member is comprised of a channel, an opening, or a groove.

14. The weather head top cap device of claim 10, wherein the fourth fastener, the second fastener, and the third fastener are comprised of threads.

15. A method of using a weather head top cap device, the method comprising the following steps:
providing a weather head top cap device comprised of a first half comprised of a member comprised of a wire-receiving member, a second half, and a cap;
attaching the first half to the second half around an exterior of a conduit;
routing a wire from the conduit through the first half and the second half and through the wire-receiving member; and
securing the cap to the first half and the second half.

16. The method of using a weather head top cap device of claim 15, wherein the first half is comprised of a first fastener and the second half is comprised of a second fastener.

17. The method of using a weather head top cap device of claim 16, wherein the first fastener and the second fastener are comprised of reciprocating fasteners.

18. The method of using a weather head top cap device of claim 15, wherein the first half is comprised of a third fastener, the second half is comprised of a fourth fastener, and the cap is comprised of a fifth fastener.

19. The method of using a weather head top cap device of claim 16, wherein the third fastener, the fourth fastener, and the fifth fastener are comprised of reciprocating fasteners.

20. The method of using a weather head top cap device of claim 15, wherein the cap is comprised of an opening.
